(19) United States
(12) Patent Application Publication
(10) Pub. No.: US 2026/0229422 A1
(43) Pub. Date: Aug. 6, 2026

(54) BUTTON STRUCTURE

(71) Applicant: CHENG UEI PRECISION INDUSTRY CO., LTD., New Taipei City (TW)

(72) Inventors: YI HSU, New Taipei City (TW); TSUNG-SHIH LEE, New Taipei City (TW)

(21) Appl. No.: 19/278,760

(22) Filed: Jul. 23, 2025

(30) Foreign Application Priority Data
Feb. 5, 2025 (CN) 202520181770.4

(51) Int. Cl. H01H 13/14

(52) U.S. Cl. CPC H01H 13/14

(57) ABSTRACT

A button structure includes a key cap, a bracket, an elastic metal element and a circuit board. A top surface of the bracket extends upward to form a hollow surrounding portion. The key cap is disposed in the surrounding portion. Several portions of an outer peripheral surface of the surrounding portion extend outward to form a plurality of locating feet. A top surface of a junction between the surrounding portion and each locating foot is recessed downward to form a notch. A bottom surface of the bracket extends downward to form a limiting portion. One end of the elastic metal element is disposed in the notches of the plurality of the locating feet of the bracket. The other end of the elastic metal element is disposed in the limiting portion. The circuit board is disposed to a bottom surface of the elastic metal element.

### CROSS REFERENCE TO RELATED APPLICATIONS

The present application is based on, and claims priority from, China Patent Application No. 202520181770.4, filed Feb. 5, 2025, the disclosure of which is hereby incorporated by reference herein in its entirety.

### BACKGROUND OF THE INVENTION

### Field of the Invention

The present invention generally relates to a button structure, and more particularly to a button structure which is capable of simplifying an assembling process and having a better assembling stability.

### Description of Related Art

A function button is a standard component in a game controller. The function button abuts against a switch of a circuit board. When the function button is pressed downward, the function button triggers the switch. The game controller executes a corresponding action. When the function button is released, the function button is returned to an initial position by an elastic force of an elastic element.

A conventional button structure includes a compression spring, a key cap, a switch, a circuit board and a shell. A mechanical arm includes the conventional button structure. The switch is disposed to a top surface of the circuit board. The circuit board is disposed in the shell. The compression spring is mounted around the switch. The key cap is disposed in a keyhole of the shell. The key cap moves with respect to the keyhole to compress the compression spring and trigger the switch. The compression spring is a polygonal spring.

However, the compression spring of the conventional button structure is used as a conductor. The compression spring of the conventional button structure is soldered to the circuit board. The compression spring and the switch of the conventional button structure are linearly arranged inside the key cap. Furthermore, an internal space of the key cap of the conventional button structure is smaller, and correspondingly a difficult assembly of the conventional button structure is caused. In addition, the key cap needs being flipped for soldering the compression spring, so assembling procedures of the conventional button structure are increased.

Thus, it is essential to provide an innovative button structure, and the innovative button structure is capable of simplifying an assembling process and having a better assembling stability.

### BRIEF SUMMARY OF THE INVENTION

An object of the present invention is to provide a button structure which is capable of simplifying an assembling process and having a better assembling stability. The button structure includes a key cap, a bracket, an elastic metal element and a circuit board. A top surface of the bracket extends upward to form a hollow surrounding portion. The key cap is disposed in the surrounding portion. Several portions of an outer peripheral surface of the surrounding portion extend outward to form a plurality of locating feet. A top surface of a junction between the surrounding portion and each locating foot is recessed downward to form a notch. A bottom surface of the bracket extends downward to form a limiting portion. The limiting portion is formed adjacent to one end of the surrounding portion. The elastic metal element is fastened to the top surface and the bottom surface of the bracket. One end of the elastic metal element is disposed in the plurality of the notches of the plurality of the locating feet of the bracket. The other end of the elastic metal element is disposed in the limiting portion, and the other end of the elastic metal element is exposed out of the limiting portion. The circuit board is disposed to a bottom surface of the elastic metal element. A top surface of the circuit board is equipped with a conductive pad. The conductive pad is corresponding to the elastic metal element and the limiting portion of the bracket. The other end of the elastic metal element contacts with the conductive pad. The other end of the elastic metal element is electrically connected with the conductive pad.

Another object of the present invention is to provide a button structure. The button structure includes a key cap, a bracket, an elastic metal element and a circuit board. An inner surface of an upper portion of the key cap extends downward to form a pressing portion. A top surface of the bracket extends upward to form a hollow surrounding portion. The hollow surrounding portion penetrates through the top surface and a bottom surface of the bracket. The key cap is disposed in the surrounding portion. An outer periphery of the surrounding portion has at least one notch. The bottom surface of the bracket extends downward to form a limiting portion. The bracket has a penetrating groove penetrating through the top surface and the bottom surface of the bracket. The penetrating groove is formed adjacent to one end of the surrounding portion. The penetrating groove is formed adjacent to one side of the limiting portion. The elastic metal element is fastened to the top surface and the bottom surface of the bracket. The elastic metal element has a connecting portion. The connecting portion passes through the penetrating groove of the bracket. A top end of the connecting portion is connected with a main portion. The main portion surrounds an outer surface of the surrounding portion. The main portion is fastened in the at least one notch. A bottom end of the connecting portion is connected with a contacting portion. The contacting portion is fastened in the limiting portion. A bottom end of the contacting portion projects beyond a bottom surface of the limiting portion. The circuit board is disposed to the bottom surface of the bracket. The circuit board is equipped with a conductive pad and a switch. The pressing portion is corresponding to the switch. The contacting portion contacts with the conductive pad. The contacting portion is electrically connected with the conductive pad.

Another object of the present invention is to provide a button structure. The button structure includes a key cap, a bracket, an elastic metal element and a circuit board. The key cap has an assembling portion. The bracket has a hollow surrounding portion, a limiting portion and a penetrating groove. The surrounding portion and the limiting portion are disposed on opposite surfaces of bracket. The surrounding portion and the penetrating groove are penetrated the bracket, the key cap is disposed in the surrounding portion. The elastic metal element has a main portion, a connecting portion and a contacting portion. The connecting portion is connected between the main portion and the contacting portion. The main portion surrounds the surrounding portion. The connecting portion passes the penetrating groove. The contacting portion is disposed in the limiting portion. The circuit board has a switch and a conductive pad. The conductive pad is electrically connected with the contacting portion. The switch is corresponding to the key cap.

As described above, the contacting portion of the elastic metal element is fastened in the limiting portion of the bracket and the contacting portion is exposed out of the limiting portion of the bracket. The contacting portion contacts with the conductive pad of the circuit board, and the contacting portion is electrically connected with the conductive pad of the circuit board. Furthermore, the connecting portion is fastened to the opening of the limiting portion of the bracket and the bottom surface of the bracket, and the main portion is fastened in the plurality of the notches of the plurality of the locating feet of the bracket. As a result, the button structure is capable of simplifying an assembling process and having a better assembling stability.

### BRIEF DESCRIPTION OF THE DRAWINGS

The present invention will be apparent to those skilled in the art by reading the following description, with reference to the attached drawings, in which:

FIG. 1 is a perspective view of a button structure in accordance with a preferred embodiment of the present invention;

FIG. 2 is a partially perspective view of the button structure of FIG. 1;

FIG. 3 is an exploded view of the button structure of FIG. 1; and

FIG. 4 is a partially exploded view of the button structure of FIG. 1.

### DETAILED DESCRIPTION OF THE INVENTION

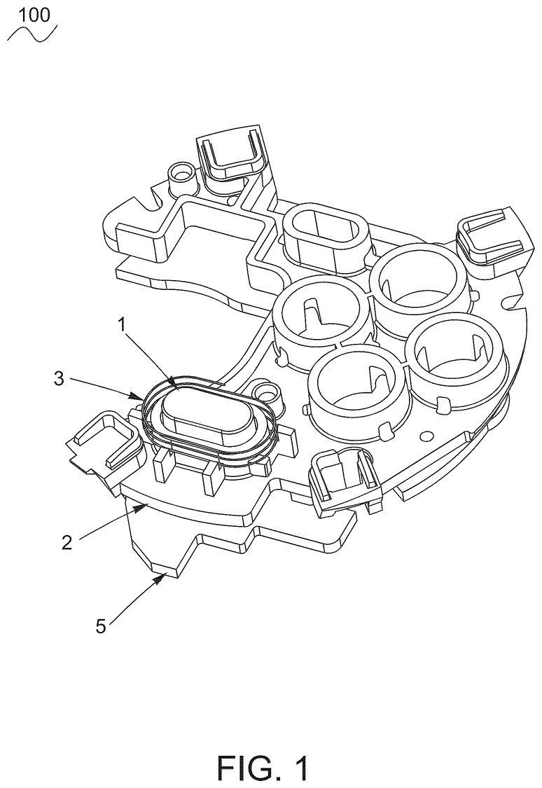

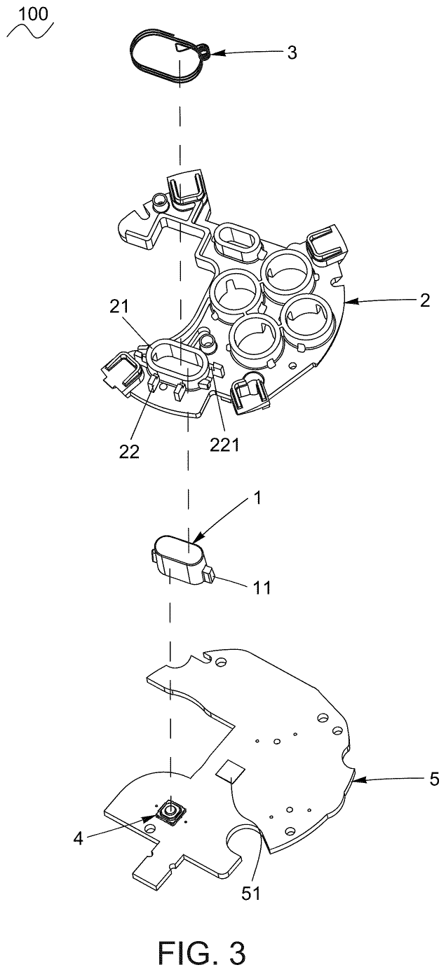

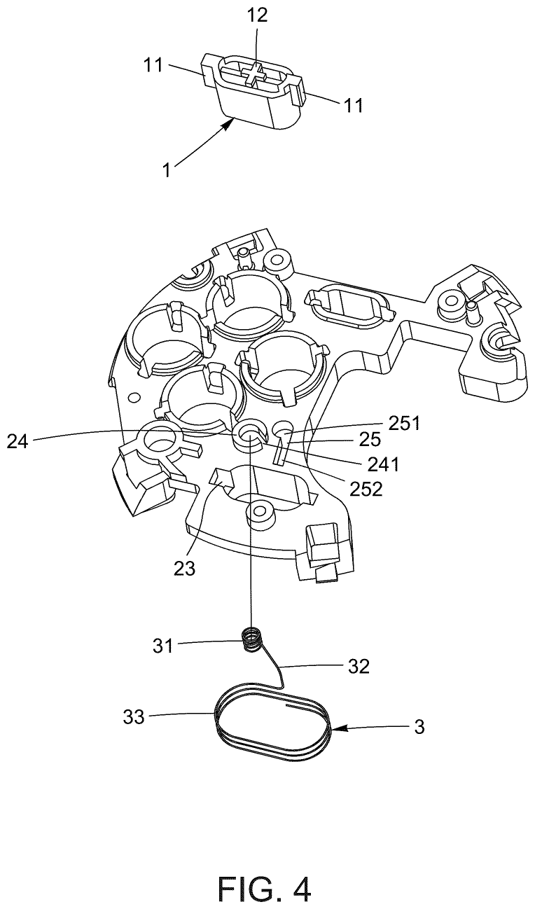

With reference to FIG. 1 to FIG. 4, a button structure 100 according to a preferred embodiment of the present invention is shown. The button structure 100 includes a key cap 1, a bracket 2, an elastic metal element 3, a switch 4 and a circuit board 5.

The bracket 2 surrounds the key cap 1. Two opposite ends of the elastic metal element 3 are fastened to a top surface and a bottom surface of the bracket 2, respectively. The circuit board 5 is mounted under the elastic metal element 3. The circuit board 5 is disposed to a bottom surface of the elastic metal element 3. The key cap 1, the bracket 2, the elastic metal element 3 and the switch 4 are disposed to a top surface of the circuit board 5. The circuit board 5 is disposed to the bottom surface of the bracket 2. One end of the elastic metal element 3 is mounted around an outer surface of the key cap 1. The other end of the elastic metal element 3 contacts with the circuit board 5. The other end of the elastic metal element 3 is electrically connected with the circuit board 5. The other end of the elastic metal element 3 and the circuit board 5 are electrically conductive.

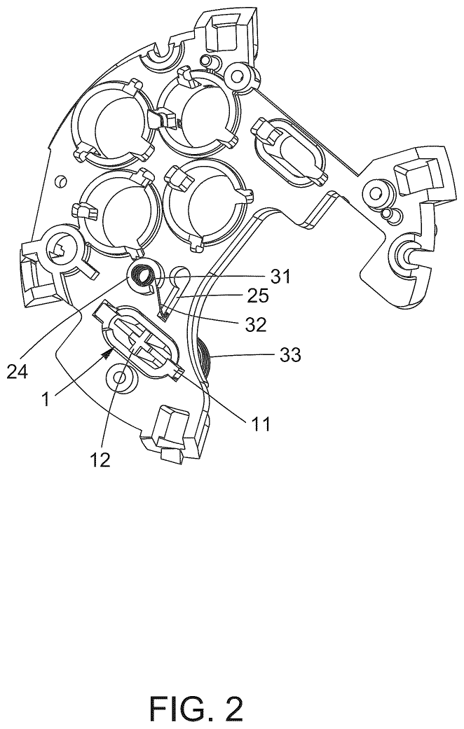

Referring to FIG. 2 to FIG. 4, the key cap 1 has a plurality of assembling portions 11 and a pressing portion 12. In the preferred embodiment, two opposite sides of the outer surface of the key cap 1 extend outward to form the plurality of the assembling portions 11. Specifically, the two opposite sides of the outer surface of the key cap 1 extend outward to form the two assembling portions 11. In a concrete implementation, the plurality of the assembling portions 11 are without being limited to be formed at the two opposite sides of the outer surface of the key cap 1. The plurality of the assembling portions 11 are disposed in corresponding mechanisms of the bracket 2 to realize that the key cap 1 is located in the bracket 2, and that the key cap 1 is fastened in the bracket 2. An inner surface of an upper portion of the key cap 1 extends downward to form the pressing portion 12. The pressing portion 12 is corresponding to the switch 4. The pressing portion 12 is used for pressing the switch 4. In the preferred embodiment, the pressing portion 12 is shown as a cross shape. In the concrete implementation, the pressing portion 12 is able to be changed from the cross shape into other different shapes, such as a circular shape or a square shape.

The bracket 2 has a hollow surrounding portion 21, a plurality of locating feet 22, a plurality of assembling holes 23, a limiting portion 24 and a penetrating groove 25. One end of the top surface of the bracket 2 extends upward to form the hollow surrounding portion 21. The hollow surrounding portion 21 penetrates through the top surface and the bottom surface of the bracket 2. The key cap 1 is disposed in the surrounding portion 21. Several portions of an outer peripheral surface of the surrounding portion 21 extend outward to form the plurality of the locating feet 22. An outer periphery of the surrounding portion 21 has at least one notch 221. A top surface of a junction between the surrounding portion 21 and each locating foot 22 is recessed downward to form the notch 221. The one end of the elastic metal element 3 is disposed in the plurality of the notches 221 of the plurality of the locating feet 22 of the bracket 2. The plurality of the notches 221 of the bracket 2 are used for locating a position of the elastic metal element 3.

The bracket 2 defines the plurality of the assembling holes 23 penetrating through the top surface and the bottom surface of the bracket 2. The plurality of the assembling holes 23 are communicated with the surrounding portion 21. In the preferred embodiment, the plurality of the assembling holes 23 are formed at two opposite sides of the surrounding portion 21. The bracket 2 has two assembling holes 23 penetrating through the top surface and the bottom surface of the bracket 2. The two assembling holes 23 are formed at the two opposite sides of the surrounding portion 21. In the concrete implementation, the plurality of the assembling holes 23 are without being limited to be formed at the two opposite sides of the surrounding portion 21. The plurality of the assembling portions 11 of the key cap 1 are disposed in the plurality of the assembling holes 23 to realize that the bracket 2 is located in the key cap 1, and that the bracket 2 is fastened in the key cap 1.

The bottom surface of the bracket 2 extends downward to form the limiting portion 24. The limiting portion 24 is formed adjacent to a bottom of one end of the surrounding portion 21. The other end of the elastic metal element 3 is disposed in an inside of the limiting portion 24, and the other end of the elastic metal element 3 is exposed out of the limiting portion 24. One side of the limiting portion 24 has an opening 241 communicated with the inside of the limiting portion 24 and an outside of the limiting portion 24. The opening 241 is close to one side of the penetrating groove 25. The limiting portion 24 is shown as an arc shape. A corresponding mechanism of the elastic metal element 3 is fastened to the opening 241.

The penetrating groove 25 penetrates through the top surface and the bottom surface of the bracket 2. The penetrating groove 25 is formed adjacent to the one side of the limiting portion 24. The penetrating groove 25 is formed adjacent to the opening 241 of the limiting portion 24. The penetrating groove 25 is formed adjacent to the bottom of the one end of the surrounding portion 21. The corresponding mechanism of the elastic metal element 3 passes through the penetrating groove 25. The corresponding mechanism of the elastic metal element 3 is fastened in the inside of the limiting portion 24 and is exposed out of the limiting portion 24.

The penetrating groove 25 has a distal portion 251 and a proximal portion 252. The proximal portion 252 is opposite to the distal portion 251. The proximal portion 252 is communicated with the distal portion 251. In the preferred embodiment, the surrounding portion 21 of the bracket 2 is closer to the proximal portion 252 than to the distal portion 251. The distal portion 251 is shown as a circular shape. The proximal portion 252 is shown as a long strip structure. One side of the corresponding mechanism of the elastic metal element 3 passes through the distal portion 251. The one side of the corresponding mechanism of the elastic metal element 3 is fastened in the inside of the limiting portion 24 and is exposed out of the limiting portion 24. The other side of the corresponding mechanism of the elastic metal element 3 passes through the proximal portion 252 and is fastened to the opening 241 of the limiting portion 24 of the bracket 2. The corresponding mechanism of the elastic metal element 3 is fastened to the bottom surface of the bracket 2.

The elastic metal element 3 has a contacting portion 31, a connecting portion 32 and a main portion 33. The one end of the elastic metal element 3 defines the main portion 33, and the other end of the elastic metal element 3 defines the contacting portion 31. The contacting portion 31 is fastened in the limiting portion 24 of the bracket 2, and the contacting portion 31 is exposed out of the limiting portion 24 of the bracket 2. The top surface of the circuit board 5 is equipped with a conductive pad 51 and the switch 4. The conductive pad 51 of the circuit board 5 is corresponding to the contacting portion 31 of the elastic metal element 3 and the limiting portion 24 of the bracket 2.

The other end of the elastic metal element 3 contacts with the conductive pad 51 of the circuit board 5. The other end of the elastic metal element 3 is electrically connected with the conductive pad 51 of the circuit board 5. The other end of the elastic metal element 3 and the conductive pad 51 of the circuit board 5 are electrically conductive. The contacting portion 31 contacts with the conductive pad 51 of the circuit board 5. The contacting portion 31 is electrically connected with the conductive pad 51 of the circuit board 5. The contacting portion 31 and the conductive pad 51 of the circuit board 5 are electrically conductive. One end of the contacting portion 31 extends outward and then extends upward to form the connecting portion 32. The connecting portion 32 is fastened to the opening 241 of the limiting portion 24 of the bracket 2 and the bottom surface of the bracket 2.

One end of the connecting portion 32 spirally extends upward to form the main portion 33. The main portion 33 is shown as a helical shape. The other end of the connecting portion 32 spirally extends downward to form the contacting portion 31. A top end of the connecting portion 32 is connected with the main portion 33. A bottom end of the connecting portion 32 is connected with the contacting portion 31. Specifically, the top end of the connecting portion 32 spirally extends upward to form the main portion 33. The bottom end of the connecting portion 32 spirally extends downward to form the contacting portion 31.

In the preferred embodiment, the main portion 33 is a circular structure. In the concrete implementation, the main portion 33 is without being limited to be the circular structure. The main portion 33 is fastened in the at least one notch 221. The main portion 33 is fastened in the plurality of the notches 221 of the plurality of the locating feet 22 of the bracket 2. The main portion 33 surrounds the outer surface of the key cap 1 and an outer surface of the surrounding portion 21. In the preferred embodiment, the contacting portion 31 is a helical annular structure. An outer diameter of the contacting portion 31 is smaller than an outer diameter of the main portion 33. In the concrete implementation, the contacting portion 31 is without being limited to be the helical annular structure.

In the preferred embodiment, the elastic metal element 3 is assembled downward to the top surface of the bracket 2. The main portion 33 of the elastic metal element 3 surrounds the outer surface of the surrounding portion 21. The contacting portion 31 of the elastic metal element 3 is aligned to an area which is located to a top surface of the distal portion 251 of the penetrating groove 25 of the bracket 2. The connecting portion 32 of the elastic metal element 3 is aligned to an area which is located to a top surface of the proximal portion 252 of the penetrating groove 25 of the bracket 2. After the contacting portion 31 of the elastic metal element 3 passes through the distal portion 251 of the penetrating groove 25 of the bracket 2, the contacting portion 31 of the elastic metal element 3 is fastened in the limiting portion 24 of the bracket 2 and the contacting portion 31 is exposed out of the limiting portion 24 of the bracket 2. A bottom end of the contacting portion 31 projects beyond a bottom surface of the limiting portion 24. After the connecting portion 32 of the elastic metal element 3 passes through the proximal portion 252 of the penetrating groove 25 of the bracket 2, the connecting portion 32 of the elastic metal element 3 is fastened to the opening 241 of the limiting portion 24 of the bracket 2 and the bottom surface of the bracket 2. The main portion 33 of the elastic metal element 3 is fastened in the plurality of the notches 221 of the plurality of the locating feet 22 of the bracket 2, so the two opposite ends of the elastic metal element 3 are assembled stably to the top surface and the bottom surface of the bracket 2.

As described above, the contacting portion 31 of the elastic metal element 3 is fastened in the limiting portion 24 of the bracket 2 and the contacting portion 31 is exposed out of the limiting portion 24 of the bracket 2, the contacting portion 31 contacts with the conductive pad 51 of the circuit board 5, and the contacting portion 31 is electrically connected with the conductive pad 51 of the circuit board 5. Furthermore, the connecting portion 32 is fastened to the opening 241 of the limiting portion 24 of the bracket 2 and the bottom surface of the bracket 2, and the main portion 33 is fastened in the plurality of the notches 221 of the plurality of the locating feet 22 of the bracket 2. As a result, the button structure 100 is capable of simplifying an assembling process and having a better assembling stability.

What is claimed is:

1. A button structure, comprising:
a key cap;
a bracket, a top surface of the bracket extending upward to form a hollow surrounding portion, the key cap being disposed in the surrounding portion, several portions of an outer peripheral surface of the surrounding portion extending outward to form a plurality of locating feet, a top surface of a junction between the surrounding portion and each locating foot being recessed downward to form a notch, a bottom surface of the bracket extending downward to form a limiting portion, the limiting portion being formed adjacent to one end of the surrounding portion;
an elastic metal element fastened to the top surface and the bottom surface of the bracket, one end of the elastic metal element being disposed in the plurality of the notches of the plurality of the locating feet of the bracket, the other end of the elastic metal element being disposed in the limiting portion, and the other end of the elastic metal element being exposed out of the limiting portion; and
a circuit board disposed to a bottom surface of the elastic metal element, a top surface of the circuit board being equipped with a conductive pad, the conductive pad being corresponding to the elastic metal element and the limiting portion of the bracket, the other end of the elastic metal element contacting with the conductive pad, the other end of the elastic metal element being electrically connected with the conductive pad.

2. The button structure as claimed in claim 1, wherein the elastic metal element has a contacting portion, a connecting portion and a main portion, the contacting portion is fastened in the limiting portion of the bracket, and the contacting portion is exposed out of the limiting portion of the bracket, the conductive pad of the circuit board is corresponding to the contacting portion and the limiting portion, the contacting portion contacts with the conductive pad, the contacting portion is electrically connected with the conductive pad, the contacting portion and the conductive pad are electrically conductive, one end of the contacting portion extends outward and then extends upward to form the connecting portion, one end of the connecting portion spirally extends upward to form the main portion, the main portion is fastened in the plurality of the notches of the bracket.

3. The button structure as claimed in claim 2, wherein the bracket has a penetrating groove penetrating through the top surface and the bottom surface of the bracket, the penetrating groove is formed adjacent to one side of the limiting portion, the penetrating groove is formed adjacent to the one end of the surrounding portion, after the contacting portion of the elastic metal element passes through the penetrating groove of the bracket, the contacting portion of the elastic metal element is fastened in the limiting portion of the bracket and the contacting portion is exposed out of the limiting portion of the bracket.

4. The button structure as claimed in claim 3, wherein the one side of the limiting portion has an opening communicated with an inside of the limiting portion and an outside of the limiting portion, the opening is close to one side of the penetrating groove, after the connecting portion of the elastic metal element passes through the penetrating groove of the bracket, the connecting portion of the elastic metal element is fastened to the opening of the limiting portion of the bracket and the bottom surface of the bracket.

5. The button structure as claimed in claim 4, wherein the penetrating groove has a distal portion, after the contacting portion of the elastic metal element passes through the distal portion, the contacting portion of the elastic metal element is fastened in the limiting portion of the bracket and the contacting portion is exposed out of the limiting portion of the bracket.

6. The button structure as claimed in claim 5, wherein the contacting portion is a helical annular structure, the distal portion is shown as a circular shape.

7. The button structure as claimed in claim 5, wherein the penetrating groove has a proximal portion opposite to the distal portion, the proximal portion is communicated with the distal portion, the surrounding portion of the bracket is closer to the proximal portion than to the distal portion, after the connecting portion of the elastic metal element passes through the proximal portion, the connecting portion of the elastic metal element is fastened to the opening of the limiting portion of the bracket and the bottom surface of the bracket.

8. The button structure as claimed in claim 1, wherein the bracket defines a plurality of assembling holes penetrating through the top surface and the bottom surface of the bracket, the hollow surrounding portion penetrates through the top surface and the bottom surface of the bracket, the plurality of the assembling holes are communicated with the surrounding portion, two opposite sides of an outer surface of the key cap extend outward to form a plurality of assembling portions, the plurality of the assembling portions are disposed in the plurality of the assembling holes.

9. A button structure, comprising:
a key cap, an inner surface of an upper portion of the key cap extending downward to form a pressing portion;
a bracket, a top surface of the bracket extending upward to form a hollow surrounding portion, the hollow surrounding portion penetrating through the top surface and a bottom surface of the bracket, the key cap being disposed in the surrounding portion, an outer periphery of the surrounding portion having at least one notch, the bottom surface of the bracket extending downward to form a limiting portion, the bracket having a penetrating groove penetrating through the top surface and the bottom surface of the bracket, the penetrating groove being formed adjacent to one end of the surrounding portion, the penetrating groove being formed adjacent to one side of the limiting portion;
an elastic metal element fastened to the top surface and the bottom surface of the bracket, the elastic metal element having a connecting portion, the connecting portion passing through the penetrating groove of the bracket, a top end of the connecting portion being connected with a main portion, the main portion surrounding an outer surface of the surrounding portion, the main portion being fastened in the at least one notch, a bottom end of the connecting portion being connected with a contacting portion, the contacting portion being fastened in the limiting portion, a bottom end of the contacting portion projecting beyond a bottom surface of the limiting portion; and
a circuit board disposed to the bottom surface of the bracket, the circuit board being equipped with a conductive pad and a switch, the pressing portion being corresponding to the switch, the contacting portion contacting with the conductive pad, the contacting portion being electrically connected with the conductive pad.

10. The button structure as claimed in claim 9, wherein the one side of the limiting portion has an opening communicated with an inside of the limiting portion and an outside of the limiting portion, the opening is close to one side of the penetrating groove, after the connecting portion of the elastic metal element passes through the penetrating groove of the bracket, the connecting portion of the elastic metal element is fastened to the opening of the limiting portion of the bracket and the bottom surface of the bracket.

11. The button structure as claimed in claim 10, wherein the penetrating groove has a distal portion, after the contacting portion of the elastic metal element passes through the distal portion, the contacting portion of the elastic metal element is fastened in the limiting portion of the bracket and the contacting portion is exposed out of the limiting portion of the bracket.

12. The button structure as claimed in claim 11, wherein the penetrating groove has a proximal portion opposite to the distal portion, the proximal portion is communicated with the distal portion, the surrounding portion of the bracket is closer to the proximal portion than to the distal portion, after the connecting portion of the elastic metal element passes through the proximal portion, the connecting portion of the elastic metal element is fastened to the opening of the limiting portion of the bracket and the bottom surface of the bracket.

13. The button structure as claimed in claim 9, wherein the bracket defines a plurality of assembling holes penetrating through the top surface and the bottom surface of the bracket, the plurality of the assembling holes are communicated with the surrounding portion, two opposite sides of the outer surface of the key cap extend outward to form a plurality of assembling portions, the plurality of the assembling portions are disposed in the plurality of the assembling holes.

14. A button structure, comprising:
a key cap having an assembling portion;
a bracket having a hollow surrounding portion, a limiting portion and a penetrating groove, the surrounding portion and the limiting portion being disposed on opposite surfaces of bracket, the surrounding portion and the penetrating groove being penetrated the bracket, the key cap being disposed in the surrounding portion;
an elastic metal element having a main portion, a connecting portion and a contacting portion, the connecting portion being connected between the main portion and the contacting portion, the main portion surrounding the surrounding portion, the connecting portion passing the penetrating groove, the contacting portion being disposed in the limiting portion; and
a circuit board having a switch and a conductive pad, the conductive pad being electrically connected with the contacting portion, the switch being corresponding to the key cap.
